(19) United States
(12) Patent Application Publication
(10) Pub. No.: US 2023/0020307 A1
(43) Pub. Date: Jan. 19, 2023

(54) A COLLAR FOR A RECESSED FIXTURE

(71) Applicant: Danny SMITH, Fareham Hampshire (GB)

(72) Inventor: Danny SMITH, Fareham Hampshire (GB)

(21) Appl. No.: 17/760,162

(22) PCT Filed: Feb. 6, 2021
(86) PCT No.: PCT/EP2021/052894

§ 371 Date: Aug. 4, 2022

(30) Foreign Application Priority Data
Feb. 6, 2020 (GB) 2001656.4

(51) Int. Cl. F21S 8/02; F21V 21/04

(52) U.S. Cl. CPC F21S 8/026; F21V 21/045; F21V 21/047; F21V 25/125

(57) ABSTRACT

There is described a collar for a recessed fixture, in particular a recessed fixture for recessing in a hole. The collar comprises a wall to extend into the hole, such wall comprising an indented catch, and such catch is arranged to catch a sprung arm of the fixture to retain the collar and fixture together with the sprung arms trapped therebetween. By providing a collar which is able to secure the fixture in a safe intermediate (not fully installed) position, it is possible to improve the efficiency and safety of installation and removal of the fixture.

### FIELD OF THE INVENTION

The present invention relates to a collar for a recessed fixture, an electric or electronic fixture recessed for example in a hole in a ceiling or similar; and/or a fixture comprising the collar; and/or a tool for installing the collar in a hole in a ceiling or similar. Embodiments of the present invention further relate to a method of installing (or partially installing) and/or removing (or partially removing) a recessed fixture using the collar.

### BACKGROUND

Increasing use of electrics and electronics is common to many societies. Many electrics and electronics may need to be recessed, into walls, ceiling, in holes.

Fixtures such as downlights, speakers or (passive infra-red) PIR sensor that have spring recess retaining arms may be retained by such sprung arms in a recess during use.

When installing or removing such fixtures it has become the practice to rely on the installation/removal person or user to try and hold the sprung arms up vertically against the downlight body while inserting or removing the downlight body through a hole, so the tension/force of sprung arms, do not allow the arms to spring down. The reliance on manually holding the arms up often results in injuring the user's fingers or damaging the recess surface. When installing the downlight body, once the downlight has been inserted far enough that the sprung arms must be released, the spring arms immediately and rapidly snap down to engage the ceiling, causing the downlight to be pulled violently up into the ceiling, potentially causing damage. When removing the downlight body, the sprung arms may cause damage to the edges of the hole until the downlight body is removed sufficiently that the sprung arms can be reached by hand.

There are products on the market to protect a ceiling and the hole cutout edges These remain in the ceiling, and do not come away with the downlights, speakers and PIR sensors. These do not offer any protection to the user whilst installing or removing fixtures. In addition, the products available on the market are not necessarily produced from fire retardant material in order to slow down the progress of fire.

### PRIOR ART

WO 2010 01 695 (OKAMURA et al) discloses a mounting assisting member and a lighting apparatus which can stably support a mounted body for a smaller mounting hole than a mounting hole of a mounting member regardless of a state of a peripheral edge portion of the mounting hole of the mounting member. In a mounting assisting member used for mounting a mounted body for a smaller mounting hole than a mounting hole provided in a mounting member to the mounting hole, the mounting assisting member, since support plate portions of the mounting assisting member come into surface contact with a peripheral edge portion in an upper surface side of a ceiling of a mounting hole by one surfaces, it is possible to lighten an influence of a concavity and convexity even in the case the concavity and convexity exists in a peripheral edge portion of the mounting hole, and it is possible to stably hold a lighting apparatus for a smaller mounting hole than the mounting hole of the ceiling to the ceiling in a predetermined direction and by a predetermined support force.

GB 2007 18 564 (HAYNES) discloses a plasterboard hole liner for ceiling down lights, maintains the strength and integrity of material into which the hole is formed, preventing damage to soft gypsum plasterboard ceilings. The hole liner may be made of metal and comprise a flange. It can be fixed either with tabs which fold out over and grip the plasterboard, or pins. The hole liner maintains pressure against the retaining springs of the downlight, for repetitive insertion and removal for decorating and for maintenance.

US 2004 0 177 572 (BURGESS) discloses an aperture edging member for forming a substantially smooth or “flush” aperture within a surface member. The edging member includes a substantially planar rim portion adapted to be attached to the surface member, a lip provided along one edge of the rim, and a flange depending from the lip in a substantially transverse direction to the rim so as to fit within the aperture. The second aspect relates to an aperture edging device which has an intermediate section with a pair of arms depending transversely therefrom to form a substantially c-shaped configuration to envelope the edge portion of the surface member. An advantage is that a strong rigid vertical face is created in the plaster board, minimizing the possibility of damage thereto. Recessed fixtures, or other fittings may be associated with the device.

The present invention arose in order to overcome problems suffered by existing devices.

### SUMMARY OF THE INVENTION

Various aspects and features of the present invention are defined in the claims.

According to one aspect of the present invention, there is provided a collar for a recessed fixture, in particular a recessed fixture for recessing in a hole, wherein the collar comprises a wall to extend into the hole, such wall comprising a catch, and such catch arranged to catch a sprung arm of the fixture to retain the collar and fixture together with the sprung arms trapped therebetween.

Preferably, the catch is an indented catch, reducing the overall diameter of the collar and/or accounting for the projection of the sprung arms from the fixture. However, the present invention may in some instances be implemented without indenting the catch.

By providing a collar which is able to secure the fixture in a safe intermediate (not fully installed) position, it is possible to improve the efficiency and safety of installation and removal of the fixture.

According to another aspect of the present invention there is provided an embodiment of the device comprising a collar for a recessed fixture, in particular a recessed fixture for recessing in a hole, wherein the collar comprises a wall to extend into the hole, such wall comprising an indented catch, and such catch arranged to catch a portion of the recessed fixture and prevent or inhibit a remainder portion of the recessed fixture passing the collar.

In this way a user is enabled to remove the recessed fixture by removing the fixture from the hole, wherein the catch catches on a portion of the fixture, meaning a portion of the fixture may be removed from the hole first, and the remainder portion of the fixture may be removed with the collar. In other implementations the collar once installed remains in the hole, and is not necessarily removed along with the fixture.

In either case the devices of the present invention provide a safe and easy way to install or remove downlights—in particular restraining a recessed fixture's sprung arms or torsion springs—such that the device may provide two key benefits, namely increasing safety by protecting the user's hands, and protecting the hole or ceiling around the hole from damage caused by the sprung arms.

The device of the present invention more particularly enables securement of the downlight's, speaker's or PIR's sprung arms in a substantially vertical position, so they cannot (or are less likely to) spring down while installing and removing the downlights, speakers or PIRs from a hole in a ceiling or wall.

In some embodiments the device may be envisaged to achieve this by substantially comprising an open-ended sleeve or wall and a catch holding the sprung arms, wherein the wall may be envisaged to be circular and the catches retain the arms and/or constrain the spring of the arms whilst a recessed fixture is being pushed into or removed from the hole.

For example the catch may comprise an indentation on two opposing sides or circumferential locations of the wall.

Such indented catches may in this way comprise a lowered or indented section of the wall, wherein the sprung arms may be envisaged to be constrained with the indentation and/or free to move in sections of the wall that are not indented or do not contain the indentation or catch.

In some embodiments therefore it may be envisaged that the indented catch comprises an indentation in the height of the wall. In other embodiments it may be envisaged that the indented catch comprises an indentation in the face of the wall, for example inner face. In still further embodiments the indented catch may comprise an indentation in both the face and height of the wall.

In some embodiments the catch comprises an indentation shaped so as to channel the sprung arms into the catch. For example the indentation may comprise a channel, or catch, wherein the sprung arms may be envisaged to become received of progressively become received or caught in the channel, as the recessed fixture passes through the collar, and/or progressively released as the recessed fixture passes in the opposing direction through the collar.

In some embodiments moulded or extending features may help to provide the catch, for example wherein ridges may retain the spring of the sprung arms, and/or may pass between members of a bipartite arm so as to better locate the sprung arm in the collar.

The catch or catches may thereby retain the sprung arms when a downlight is being pushed into or removed from the hole in a ceiling.

The catch may comprise a locking mechanism arranged to lock the arms to the collar. Alternatively or additionally the catch may be envisaged to engage the collar to the fixture. For example the locking mechanism may enable the fixture to be locked to the collar and the sprung arms locked in a substantially vertical orientation.

In some embodiments the catch comprises the locking mechanism. In some embodiments such locking mechanism may comprise a resiliently deformable and/or cam mechanism, such that a lock is automatically engaged during movement in a preferred direction, for example opposing linear movements of the fixture and collar, so that the locking mechanism engages when the fixture and collar are displaced. In this way once the fixture and collar are proximate the sprung arms may be released, and enabled to hold the fixture in place as known in the prior art.

This locking mechanism may be engaged or disengaged when the collar and fixture are proximate such that the locking mechanism may be engaged or disengaged for displacement of the fixture away from or into the hole.

In some embodiments the locking mechanism may require rotation of the fixture or collar to engage or disengage.

In some embodiments it may be envisaged that the arms give an audible noise as the spring arms locate in the catch or indentation or channels, and/or ride over the locking mechanism, allowing the user to know the arms are aligned and in the correct position. It may be envisaged that the springs constantly produce an outward force which cause the arms to push out, thereby helping to stop the collar from sliding up and over the top of the fixture.

The locking mechanism provides a means for mechanically locking the collar from slipping up and over the top of the fixture, and a means for stopping the collar from sliding back down due to pressure from the sprung arms. The channel in turn provides means for guiding the arms to locate them over the catches, preventing the arms springing open when free resulting in injury to the user or damage of the hole.

In some embodiments the collar comprises a cutout for a fixture's electrical transformer box.

Some embodiments may comprise a lip to stop the collar going up into the hole.

Some embodiments may comprise a slot in the lip to visually see the orientation of the collar with reference to the hole, transformer, fixture or arms.

Alternatively, the collar may comprise a guide for positioning the sprung arms in line with the channel when the catch is not engaged with the sprung arms. In this way, the sprung arms will either be constrained or encouraged to remain or move in line with the channel, even when they are outside of the channel itself. Where two catches are provided to engage with two sprung arms, two guides will be provided, one each for the two sprung arms. The guides may each take the form of a shaped end of the wall of the collar. In particular, where the end of the collar having the lip is the first end, the guide(s) are provided at the second end. The shaping for each guide may comprise a pair of protrusions defining a guide region therebetween for receiving and controlling the sprung arm.

In some embodiments the collar may comprise a visual marker to enable the user to recognize where the catches are located on the circumference of the collar or lip, for example with cutouts in the bottom of the lip allowing the user to recognise the catch location(s).

In another embodiment provided by the present invention, the collar includes a large cut out wherein, when the collar is in use, an electrical transformer box and an electrical transformer box mounting of the fixtures are allowed to sit within the collar allowing the collar to be raised fully. The collar may be arranged such that the height of the wall is lower than the fixture's spring coils, with reference to standard ceiling depths, allowing normal function of the fixtures when installed.

The collar may be a moulded ring of plastic, fireproof or otherwise, and in some embodiments may comprise an intumescent material, for example around the lip, and may be and flexible, and provided as a fireproof part, but can also be manufactured from non-fireproof plastic for use where fire regulations allow the invention to be installed as a non-fireproof product.

When removing the light, the user must push against the lip whilst pulling the fixture out of the hole. This will cause the spring to slowly compress in a controlled manner and allow the user to pull the fixture out of the hole without the risk of the spring causing damage to the user or the hole.

The catch may comprise a slot having a substantially flat base, the slot for receiving a substantially linear end portion of the sprung arm. The slot is preferably disposed (within the channel) between a first sloped stud (or studs) and a second sloped stud (or studs). In this way, the end of the sprung arm rests substantially evenly against the base of the slot, making it engage more securely with the catch and making it less likely to jump out.

An exterior surface of the wall may comprise screw threading for screwing the collar into the hole. The screw threading may comprise a sharp leading edge for cutting into the material around the edges of the hole through which the collar is being inserted. It will be appreciated that alternative ways of fixing the collar into the hole may be used instead, such as tabs, clips or collars.

The collar may comprise one or more engagement formations for engaging with a tool. The engagement formations may comprise engagement slots within the inner surface of the wall, preferably at the first end thereof. The engagement slots may be shaped and/or dimensioned such that if a rotational torque applied by the tool exceeds a predetermined threshold, the tool will jump out of the collar. It has been found that this can be achieved effectively if the engagement slots extend less than 10 mm, preferably less than 7 mm, still more preferably less than 6 mm and most preferably approximately 5 mm, from an edge of the collar wall receiving the tool.

According to a second aspect of the present invention the device comprises a collar substantially as described herein, fitted to a recessed fixture.

Viewed from another aspect, there is provided a tool for installing the collar as described above into the hole, the tool comprising one or more engagement formations for engaging with the engagement formations of the collar, wherein rotation of the tool while engaged with the collar causes the collar to be screwed into the hole via the screw threading. It will be understood that the relative positions of the engagement formations on (and preferably about the periphery of) the tool match the relative positions of the engagement formations of the collar (and optionally those of the channels, where some of the engagement formations of the tool engage with the channels of the collar).

The tool may comprise an engagement surface for insertion within the inside of the wall of the collar, the engagement surface comprising one or more protrusions around its periphery which are complementary in shape with the engagement slots in the inner surface of the wall. The protrusions may be shaped and/or dimensioned such that if a rotational torque applied by the tool exceeds a predetermined threshold, the tool will jump out of the collar. It has been found that this can be achieved if the engagement formations, when the tool is fully engaged with the collar, extend less than 10 mm, preferably less than 7 mm, still more preferably less than 6 mm and most preferably approximately 5 mm, into the collar.

The tool may further comprising a drive connector, for receiving a drive tool for applying rotational torque via the tool to drive the collar into/onto the hole.

Viewed from another aspect, there is provided a method of installing a fixture into a hole, the method comprising: fixing a collar as described above onto the hole, for example using a screw thread, and preferably using the dedicated tool described above, deflecting the sprung arms of the fixture upwards and against the body of the fixture, pushing the fixture up through the collar until the end member of each sprung arm engages with the catch. This method partly installs the fixture. Subsequently, the fixture is fully installed by pushing the fixture further upwards through the collar, so that the sprung arms disengage the locking arrangement, and the fixture moves into a fully installed state.

Viewed from another aspect, there is provided a method of partially uninstalling the fixture, the method comprising: pulling the fixture through the collar, thus causing the sprung arms to be deflected towards the body of the fixture; continuing to pull the fixture through the collar with the sprung arms sliding along the channel, until the end members of the spring arms engage with the catch. This method partly removes the fixture. Subsequently, the fixture can either be fully reinstalled from this position by pushing the fixture upwards through the collar, so that the sprung arms disengage the locking arrangement, and the fixture moves into a fully installed state. Alternatively, if the fixture is to be fully removed, the method comprises gripping the exposed portions of the sprung arms, then pulling the fixture to release the sprung arms from the catch, and then releasing the sprung arms into their rest position. The fixture can then be electrically disconnected and fully removed if required.

Several preferred embodiments of the invention will now be described by way of example only and with reference to the Figures in which:

### BRIEF DESCRIPTION OF FIGURES

FIG. 1 shows isometric views of different stages of use of a first embodiment of the collar and recessed fixture of the present invention;

FIG. 2 shows an isometric view of the first embodiment of the collar and recessed fixture shown in FIG. 1;

FIG. 3 shows an isometric view of the first embodiment of the collar shown in

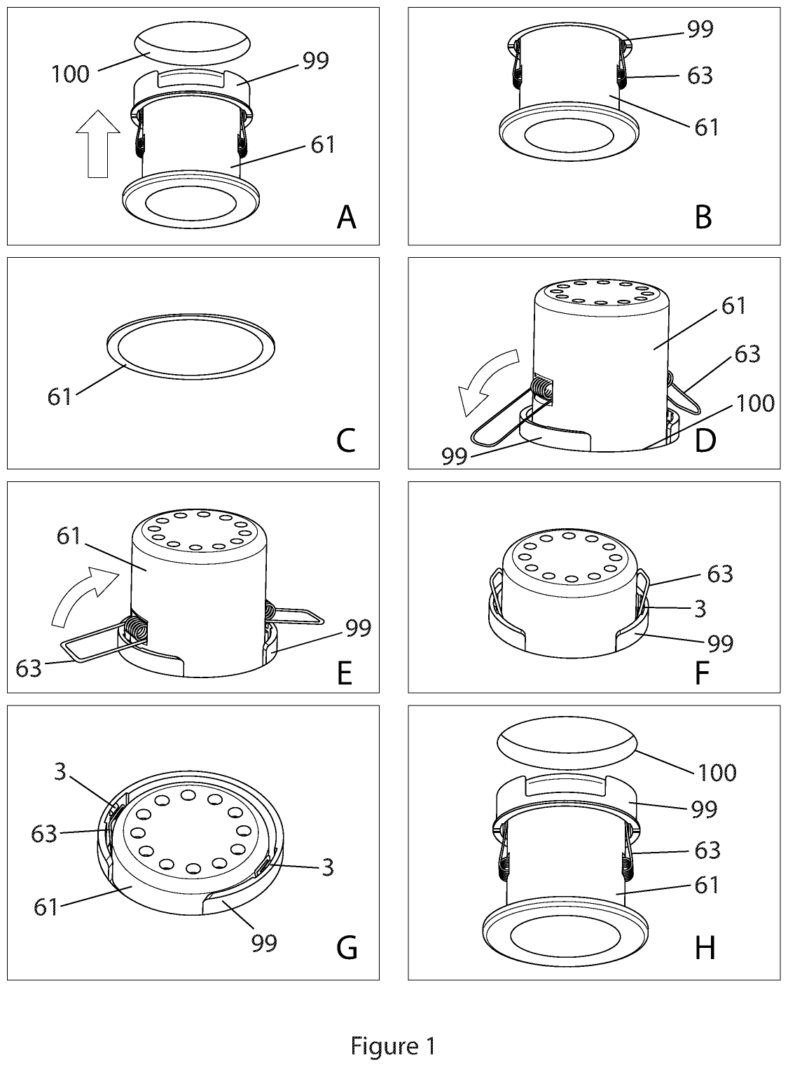

FIG. 1;

FIG. 4 shows an isometric view of a second embodiment of a collar according to the present invention;

FIG. 5 shows a reverse isometric view of the second embodiment of the collar shown in FIG. 4;

FIG. 6 shows an isometric view of the second embodiment of the collar shown in FIG. 4, in use on an embodiment of a fixture;

FIG. 7 shows an isometric view of the second embodiment of a collar according to the present invention;

FIG. 8 shows an isometric view of the second embodiment of the collar shown in FIG. 4;

FIG. 9 shows an isometric view of a third embodiment of a collar according to the present invention;

FIG. 10 shows a reverse isometric view of the third embodiment of the collar shown in FIG. 9; and

FIG. 11 shows a tool for installing the collar of the third embodiment.

### DETAILED DESCRIPTION OF FIGURES

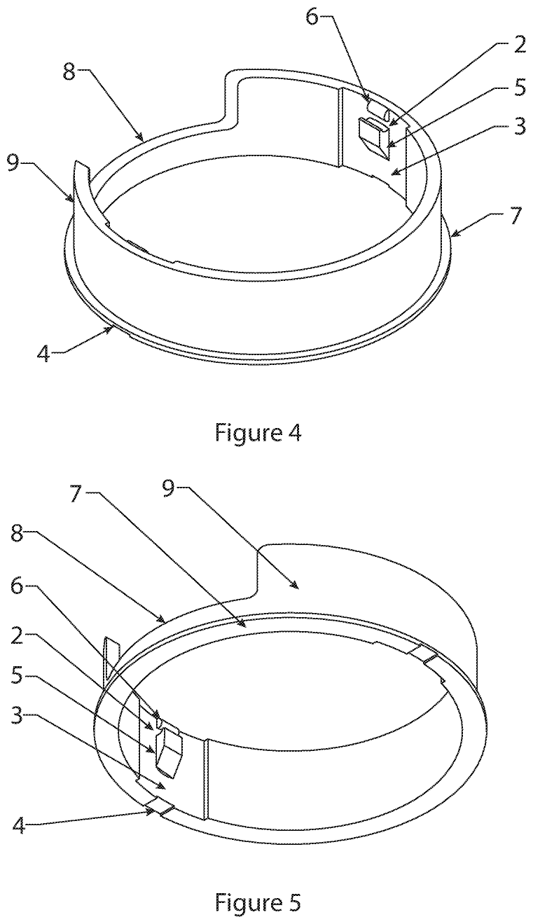

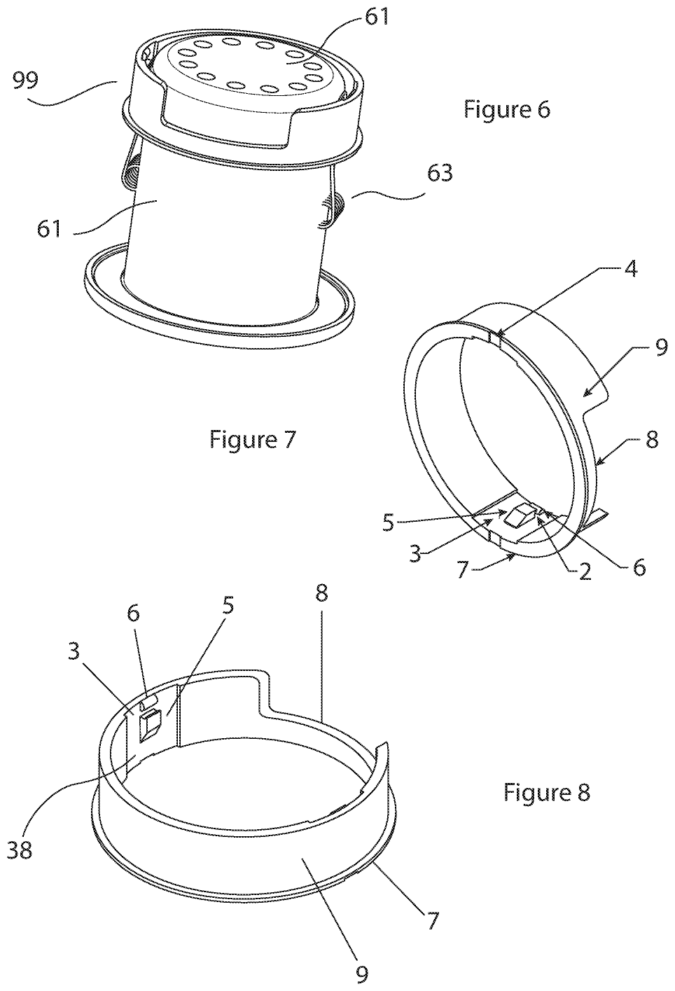

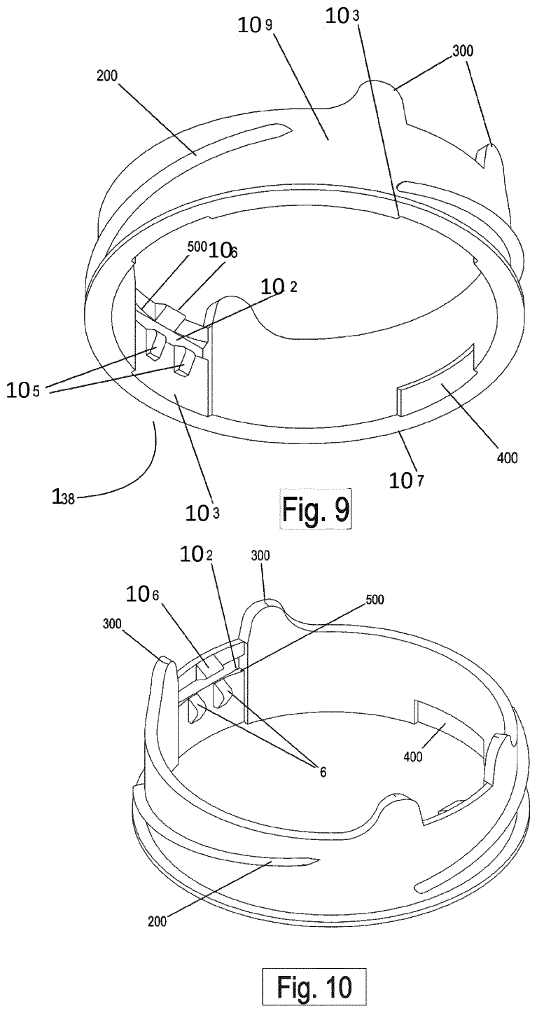

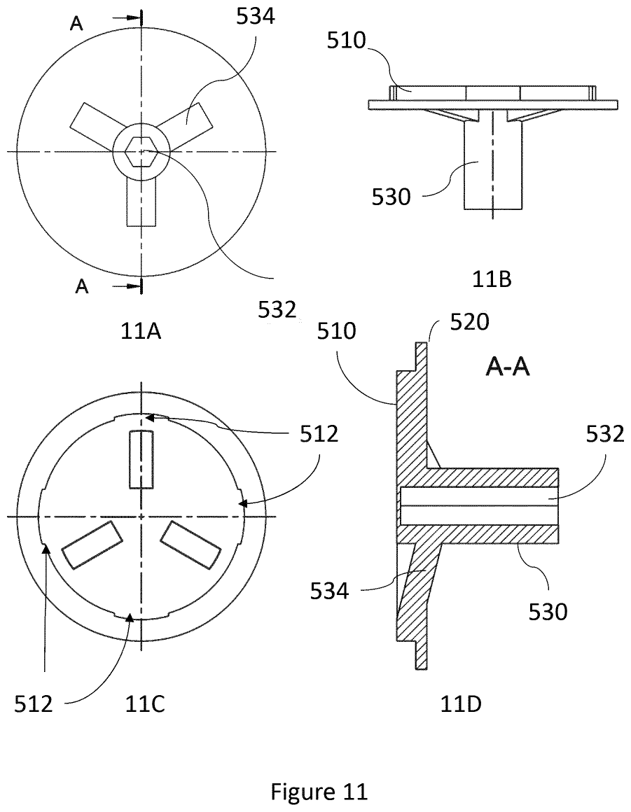

With reference to FIGS. 3, 4, 5, 7 and 8 there is shown embodiments of the device generally comprising a collar 99 for a recessed fixture, in particular a recessed downlight 61 for recessing in a hole 100, wherein the collar comprises a wall 9 to extend into the hole, such wall comprising an indented catch 38, and such catch 38 arranged to catch the sprung arms 63 of the fixture and prevent, or at least inhibit, the fixture wholly passing the collar. In particular, the catch 38 is arranged to catch the sprung arms of the fixture to retain the collar and fixture together with the sprung arms trapped therebetween. The collar may be referred to in some implementations as a downlight protection collar.

Typically, fixtures are provided with two sprung arms, at opposite sides of the fixture from each other, although it will be understood that the same principles would apply for a different number of sprung arms. In order to function with a fixture having two sprung arms to opposite sides of the fixture, the collars described herein comprise two catches, one to each side of the collar, for respectively engaging the two sprung arms.

The collar 99 is defined generally by a cylinder or ring (annular structure) having various features, formations and structures for interacting with the hole, the surface in which the wall is formed, the sprung arms 63 of the fixture, and the body of the fixture.

The catch 38 is indented by being disposed within a channel 3 formed in an interior surface of the collar 99. The catch 38 may be considered to include the channel 3 as well as other structures (described subsequently) for engaging or otherwise interacting with the sprung arms 63 of the fixture. The channel 3 of the catch is sufficiently deep to accept passage of the hinges of the arms (which typically protrude from the main body of the fixture, as apparent from the Figures). The collar is envisaged to be held in one hand of the user during installation and removal. The collar 99 is designed to be injection moulded with a simple two-part mould.

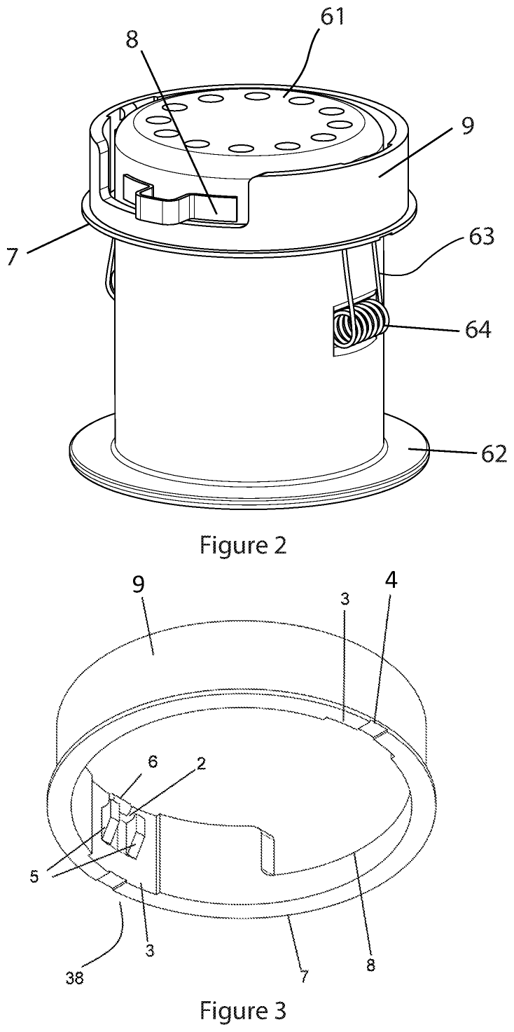

With reference to FIGS. 1, 2 and 6 there is shown an embodiment of the device generally comprising the collar 99 and the downlight fixture 61.

Referring to the 8 images in FIG. 1, these respectively show (A) the collar 99 and fixture 61 fixed together but not yet located within the hole 100. The sprung arms of the fixture 61 are controlled in this position while they are inserted together into the hole 100, as shown in (B). In particular, in (B) the collar 99 is received fully in the hole 100. In (C), the fixture 61 has been pressed fully up into the hole, through the collar 99. Images (A) to (C) are all viewed from beneath the ceiling within which the hole 100 is provided. In image (D), the configuration of the collar 99 and fixture 61 is shown when the collar 99 and fixture 61 are fully installed within the hole 100 (that is, the same as with (C). It can be seen that the sprung arms of the fixture 61 have pivoted down to engage with the upper surface of the ceiling, thus urging the fixture 61 up fully into the hole 100, with the collar 99 being trapped between the fixture 61 and the ceiling. In (E), the fixture 61 is being removed from the hole 100, by being pulled downwards while the collar 99 is still (held) in place against the ceiling. It can be seen that the sprung arms are deflecting upwardly towards the fixture 61. As the spring base of the arms moves into the collar, the sprung arms adopt a substantially upright position along the side of the fixture 61, as shown in (F). The sprung arms remain in this position as they are pulled along with the fixture 61 through the collar 99, as shown in (G). The sprung arms are eventually caught by a catch on the collar, enabling the collar 99 and fixture 61 to be removed together, as shown in (H).

The collar may be moulded plastic such as polyethylene or acrylonitrile butadiene styrene (ABS) and/or intumescent material and may be envisaged to be flexible in nature. Preferably, the collar is formed from a VO fireproof material or equivalent. This allows the collar to be resiliently deformed to accommodate any protrusions from the fixture as the fixture passes through the collar (or equivalently the collar passes over the fixture).

The wall 9 is circular in cross section and the collar comprises a laterally extending lip 7 at a first (the bottom) end of the wall. The lip 7 (which may also be referred to as a flange or rim) extends outwardly from the first end of the wall, one face of the lip 7 being for resting against the edges of the hole, the opposite face of the lip 7 generally being hidden by a lip of the fixture 61. Intumescent material may be located at or on the lip 7, to create a fireproof and smokeproof seal around the edges of the hole in the event of a fire.

As described above, the interior surface of the wall 9 (or explained differently, the indented catch) comprises a vertical (catch) channel 3, with a locking mechanism 2 at its top end (proximate a second, top, end of the wall 9, opposite to the first, bottom, end of the wall).

The channel 3 extends from the top (second end) of the wall to the bottom (first end) of the wall.

The locking mechanism 2 in the first embodiment comprises three projections from the (bottom) surface or base of the channel.

Of the three projections, two central projecting studs 5 provide inclined bottom faces and indented upper faces, such that the end of a spring of a sprung arm (known in the art and as shown in FIGS. 1, 2 and 6) is enabled to ride over the bottom face when first inserted into the catch, and spring back to lock onto or over the top face. Above the central studs 5 a top stud 6 provides a curved bottom face and curved top face (which may be described as a bump), such that the arm end is enabled to ride over the top stud in either direction, when sufficient pressure is exerted by a user to move the fixture with respect to the collar. While sufficient user-applied pressure in either direction is sufficient to disengage the sprung arms from their respective catches (the amount of pressure may differ in each direction, in dependence on the geometry of the studs over which the sprung arms will need to traverse to escape the catch and the angle of the sprung arms and the amount and direction of spring loading forces generated through the sprung arms), it will be understood that the forces generated by/through the sprung arms will not be sufficient to disengage the sprung arms from the catches absent additional forces being applied by the user to install or remove the fixture.

With reference to the second pictured embodiment (FIGS. 4 and 5) the locking mechanism comprises a sloped central stud and a top stud, wherein the two studs are in line and situated centrally in the channel and the central stud replicates the two central studs of the first embodiment.

By twisting the collar clockwise and anti-clockwise the user can check if the arms are located correctly within the catch channels and if they are not, a twisting action will allow the arms to find and open out into the channels with an audible click, as they position themselves in the channels.

After locating the sprung arms of the downlights into the channels the collar is pushed further over the downlights to assemble it completely until the arms ride up the central studs and lock over the top of them where they are held in place by the locking mechanism, ensuring that the collar is not pushed too far down that the arms override the top stud.

The first and second embodiments are shown with central stud(s) and a top stud to form an intermediate locking mechanism 2 to give a positive distance stopping. The collar may then be pulled back up until the end of the sprung arm locates in the locking mechanism, and the downlight electrical transformer box (not shown) and mounting bracket locates in a cutout 8 or indent in the wall 9.

It may be envisaged that during installation the electrical transformer box is pushed up into the hole first at an angle, the collar is then inserted into the hole until the lip touches the hole, the downlight is then be pushed home as normal. The cutout in the wall allows sideways passage of a transformer.

The collar can then be pushed fully home (substantially) flush with the hole so the hole 100, fixture 61 and lip 7 of the collar 99 are in contact.

For removal while holding the collar 99 in place the downlights can be pulled out of the hole until it stops, an audible click is heard, as the arms ride over the top stud and ends of the arms will be located in the locking mechanism. The arms will be visible from the bottom of the lip wherein there is a slot 4 each side in the lip 7 to see the orientation of the collar with reference the arms.

During installation, the lip is used to push against the ceiling or hole and separate the fixture and collar.

In use therefore, to install the collar and fixture:
Insert the fixture and collar into the ceiling with the arms engaged with the locking mechanism.
The lip of the collar pushes against the ceiling, preventing it from moving further.
Push the fixture further, through the collar and into the ceiling, so that the arms disengage from the locking mechanism and slide within the channel 3.
The sprung arms, no longer locked in place, will urge the fixture through the collar (or explained differently, urge the collar along the fixture), until the lip 7 of the collar is sandwiched between the lip of the fixture and the ceiling/hole.
During the process, the spring will fold down in a controlled manner.
The collar will stop when it hits the ceiling.

When removing the fixture:
Pull the fixture downwards.
Hold the lip against the hole.
As the fixture is pulled through the collar, the collar will push the arms upwards and into the channel 2.
Eventually, the arms will clip into the locking mechanism, securing the fixture and collar together.
The fixture and collar can then be move down and removed together.

As a result, the fixture can be removed from the ceiling without the risk of the arms snapping downwards.

Referring to FIGS. 9 to 11, there is shown a third embodiment of a collar 199 for a recessed fixture such as the recessed downlight 61 described earlier, for recessing in a hole 100. As with the first and second embodiments, the collar comprises a wall 109 to extend into the hole, such wall comprising an indented catch 138, and such catch 38 arranged to catch the sprung arms 63 of the fixture to retain the collar and fixture together with the sprung arms trapped therebetween, and thus to inhibit the fixture wholly passing the collar. A channel 103 is provided, similar to the first and second embodiments, as is a locking mechanism 102 comprising studs 105, 106 generally equivalent (subject to differences described below) to the studs 5, 6 of the first and second embodiments.

However, unlike the first and second embodiments, the collar 199 of the third embodiment is intended to be installed in the hole 100 prior to engagement with the fixture 61, and when the fixture 61n is removed, the collar 199 is intended to remain in the ceiling. As a result of the fixing of the collar 199 to the hole, the user does not need to grip the collar when withdrawing the fixture. The user need only concentrate on smoothly withdrawing the fixture from the hole and through the collar 199.

This is achieved by providing the collar 199 with an external threading 200 which enables the collar 199 to be screwed (rotated) into the ceiling, securing it in place. Once screwed in (for example in a clockwise direction), a force applied to pull the collar directly out of the hole will not release the collar 199 from the hole. Instead, if the collar 199 is to be removed, it will need to be rotated out of the hole (for example in an anticlockwise direction). As will be explained subsequently, a dedicated tool may be used to rotate the collar 199 into engagement with the hole—although it will be appreciated that it may instead be screwed in by hand. The screw threads 200 shown in FIGS. 9 and 10 comprises three integral helical screw threads providing a means to anchor the collar 199, to the material thorough which it is inserted. The integral screw threads 200 also have a sharp leading edge, thereby providing a way of cutting into the material though which the collar 199, is inserted during installation.

While all three embodiments provide an improved seal around the hole into which the downlighter is installed, thereby reducing the likelihood of smoke passing through the hole in the event of a fire (noting that the fixture itself will generally be provided with intumescent parts to create a seal within the fixture), the third embodiment provides a tighter seal than the first and second embodiments, due to the screw threading engaging with the material of the ceiling, and the ability to provide the collar as a tighter fit within the hole due to the fact that it is not intended to be removed with the fixture (unlike the first and second embodiments).

In order to permit the use of a dedicated tool for installing the collar 199 into the hole, the collar 199 is provided with tool engagement slots/recesses 400 on the inside surface of the first end of the wall to engage with corresponding formations of the tool. The engagement slots 400 may be cutouts, indents or other concave formations defined in the inner surface of the wall 109. These may have the same radial depth and circumferential length as the channels 103, so that the protuberances of the tool can readily engage either the dedicated engagement slots 400 or the channels 103. FIG. 11 shows an example of a tool 500 suitable for this purpose. It will be appreciated that the tool engagement slots 400 on the collar provide a structure by which the installation tool, with corresponding protuberances matching the same geometry as the tooling engagement slots can engage with the collar 199 in order for it to be installed. Two engagement slots 400 and two channels 103 are provided in the present example, equally disposed around the inside surface of the wall proximate its first end. As such, the tool uses four protuberances, two each for the engagement slots 400 and channels 103.

Referring to FIG. 11, the tool 500 can be seen to comprise a collar engagement plate 510, a peripheral rim 520 and a central drive stem 530. The central drive stem 530 comprises a hexagonal internal bore 532 for receiving a drive shaft, such as a hexibar or dedicated power drill extension. The drive shaft is driven to rotate either by hand or motor torque, and this drives rotation of the tool 500. The tool 500 can be driven in a first direction (for example clockwise) to screw the collar into/onto the hole, and in a second direction (for example anticlockwise to unscrew and remove the collar from the hole.

A plurality (in this case three) of reinforcement struts 534 are provided to ensure that the central drive stem 530 does not shear away when the drive shaft is rotated therein. The collar engagement plate is generally circular, but comprises a series of (in this case four, but other numbers are also viable) protuberances 512, disposed around the periphery of the plate and extending outwardly (radially), which are shaped and dimensioned to engage with the tooling engagement slots in the collar. Note the four protuberances 512, two (opposing ones) for engagement with the engagement slots 400 and two (opposing ones) for engagement with part of the channels 103. It will be appreciated that, in use, the collar engagement plate 510 is inserted into the first end of the collar 199 with the protuberances 512 being received in the tooling slots. The rim 520 is brought to rest against the first end of the collar (the lip 7) such that the collar engagement plate 510 is fully received and is less likely to jump out of the collar upon rotation thereof. However, in order to avoid damage to the collar and/or the ceiling and/or the tool, the rim 520 only permits the collar engagement plate 510 to extend a controlled distance (in the present example 5 mm), such that if the applied torque exceeds a predetermined threshold, the collar engagement plate 510 will jump out of the collar. In alternative embodiments, the rim 520 may not be required, with control of the depth of the tool into the collar being achieved by the limited depth of the engagement slots 400.

It should be understood that the slots on the collar 199 and the protuberances on the tool 500 may be reversed, although this is less preferred due to the risk of protuberances inside the collar 199 fouling on parts of a light fixture.

It will be noted that the slot 4 (used to provide visibility of sprung arm position) present in the first and second embodiments is not present in the third embodiment. Instead, guide bumps/protuberances 300 are provided at the top edge of the collar, which serves to make sure that the downlighter spring clips are in the correct place at all times and also guides the springs into the indented catch 38. Since two sprung arms are to be caught, two guides are preferably provided (although the rotational position could be controlled simply by guiding one of the sprung arms). The guides are disposed at opposing positions about the circumference of the second end of the collar 199. Each guide comprises a pair of protuberances defining a guide region therebetween. The pair of protuberances have a steep (and preferably substantially vertical) inside edge (the edges of the pair generally facing towards each other) so that the sprung arm does not easily slide out with rotational movement of the fixture, and a shallower and preferably smoothly curved outside edge (the edges of the pair generally facing away from each other) to engage the sprung arms to pass over the protuberances and into the region between when they are currently outside of the guide. In an alternative implementation the guides could instead each be provided as a recess in the second end of the collar 199.

The sprung arms of a fixture such as that shown in the Figures take the form of a pair of elongate members each connected at one end via a biased spring part at or inside the body of the figured, and at the other end by a shorter end member at approximately a right angle to the pair of elongate members. It is the end member which engages with the locking arrangement, and in particular is caught between the studs 105, 106. However, because in the first and second embodiments the end member is straight while the inside surface of the collar between the studs 5, 6 is curved, the end member does not rest closely to the inside surface of the collar when trapped between the studs 5, 6. As a result, the sprung arms are more likely to shift position, and potentially escape from the catch. With the third embodiment, and as visible in FIGS. 9 and 10, a spring retaining slot 500 is defined between the upper and lower studs 105, 106, the slot having a substantially flat base (in contrast to the generally curved inside surface of the collar both inside and outside the channel 3) which the end member of the arms can rest against. With this structure, the sprung arms are less likely to shift position and escape the catch. The spring retaining slot allows the spring from the downlighter to engage in the indented catch 138 in such a manner as not to impede the aperture of the collar 199.

The shape of the protuberances (studs), 105 and 106 have also changed for the third embodiment (compared with the studs 5, 6 of the first and second embodiments) to allow easier and smoother engagement of the downlight spring clips. In particular, the central studs 105 are sloped in both directions, to a point, with a shallower slope to the side of the studs 105 proximate the first end of the collar 199 than the slope to the side of the studs extending down into the slot 500. The top studs 106 are shaped (compared with the first and second embodiments) more steeply and to a point, in both directions. The angle of the slopes (on both upper and lower sides of the top studs 106) is approximately 60°. The slope of the lower side of the top studs 106 extends down into the slot 500. This geometry for the studs 105, 106 has been found to retain the end part of the sprung arms securely (within the slot 500), while permitting it to enter and exit the catch via the central studs 105 and the top studs 106 with an appropriate amount of user pressure on the fixture. Note that the amount of user applied force/pressure required to engage the catch by forcing the sprung arms over the central studs 105, the amount of user applied force/pressure required to engage the catch by forcing the sprung arms over the top studs 106 (that is, in the opposite direction), the amount of user applied force/pressure required to disengage the catch by forcing the sprung arms over the top studs 106 and the amount of user applied force/pressure required to disengage the catch by forcing the sprung arms over the central studs 105 may all be the same, may all be different, or a combination of the same or different.

The laterally extending lip 107 may have a coating of intumescent paint or a gasket of Intumescent material added. In the event of fire the intumescent expands and seals the gap between the collar 199 and the downlight bezel stopping fire, smoke and gasses from being able to get access to the aperture and subsequently spreading between floors via the ceiling/wall/floor cavity.

The method of installation and removal of a fixture using the collar of the third embodiment differs from that of the first and second embodiments. In particular, installation is carried out as follows:
(i) The collar is screwed onto the hole using the dedicated tool, the lip of the collar abutting the ceiling in order to create a tight seal;
(ii) The electrical parts of the fixture, such as power cable and transformer, are passed through the collar and into the space above the whole, and connected up to the mains power;
(iii) The sprung arms of the fixture are deflected upwards and against the body of the fixture, and the fixture is pushed up through the collar, with the sprung arms in line with the channel;
(iv) The fixture may be rotated in each direction until the arms click into the channel (which should result in an audible click and/or tactile feedback due to the strength of the spring);
(v) The fixture is pushed up further through the collar until the end member of each sprung arm engaged with the studs (again, with an audible click/tactile feedback);
(vi) The fixture can be left in this state by an electrician, who will generally have carried out the above steps, the state being that the fixture is electrically connected and mechanically secured, but not flush with the ceiling;
(vii) Any decoration can take place without the fixture (e.g. the front bezel thereof) interfering;
(viii) Once the decorating is complete, and any paint dried, the decorator is able to push the fixture further upwards through the collar, so that the sprung arms disengage the locking arrangement;
(ix) As the decorator continues to push the fixture through the collar, the sprung arms will start to act on the collar to draw the fixture through it, and finally into engagement with the lip 7, with the sprung arms ensuring that the fixture is held firmly against the lip 7 and/or the surrounding ceiling.

Conventionally, an electrician is required to visit twice. Once to initially install the light fixtures (but leave them dangling), and again to fit the light fittings into the ceiling following decoration (which would be carried out by a decorator). It will be appreciated that the above process of the present invention, facilitated by the catch, means that an electrician does not need to come back a second time, since the fixture is already secured in the ceiling, and merely requires a push from beneath (which does not require an electrician) to place it into its final position.

Removal of the fixture is carried out as follows:
(i) The fixture is pulled down away from the collar, which will cause the sprung arms to be deflected away from the ceiling and up towards the fixture itself;
(ii) The guide bumps on the collar will ensure that the sprung arms are guided into the channel (if necessary with manual rotation of the fixture) as they move towards and into a vertical position against the fixture;
(iii) The sprung arms will slide along the channel 103, until the end members of the spring arms engage with the catch, again with an audible click and/or tactile feedback;
(iv) The fixture may be left secured in this position, for example while the surrounding ceiling is redecorated, following which it can be reinserted by following steps viii and ix above under the installation method;
(v) If the fixture is to be fully removed, the user will grip the exposed portions of the sprung arms (visible below the ceiling), then pull the fixture to release the sprung arms from the catch (noting that the manual gripping of the sprung arms will assist with releasing the sprung arms from the catch);
(vi) The sprung arms can be carefully released into their rest position, and the fixture can be electrically disconnected and fully removed.

It will be appreciated that this makes removal of the fixture safer, because the springs are controlled by the collar until the catch engages the sprung arms, so the user does not need to reach through the hole to manipulate the sprung arms for removal through the hole. There is also no surprise as to when the sprung arms spring free, since the collar entirely controls the sprung arms until the catch engages, and the user can then carefully further withdraw the fixture while holding the sprung arms safely.

It will be understood from the above that the collar as described provides a wide range of benefits. Firstly, the collar reduces the likelihood of the sprung arms pinching, trapping or otherwise injuring the user during installation and removal. Secondly, the collar prevents spring damage to the ceiling (which conventionally must be repaired and redecorated), because the edges of the hole are protected. Thirdly, the collar centralises the fixture to the hole, and reduces movement of the fixture within the hole, providing aesthetic benefits because the fixture is located precisely where it was intended. Fourthly, the tight fitting of the collar to the hole, and the fixture within the collar, results in a better seal to reduce smoke and fire passing through in the event of a fire. As discussed, this effect can be further improved by incorporating intumescent rings or surfaces into the collar design, for example at the lip 7, and/or on the inside surface of the wall of the collar. The collar is dimensioned to fit a wide variety of the light fittings, assisted by the ability of the collar to flex due to the materials used. The thread of the third embodiment enables the collar to work in any depth of the ceiling material.

The invention has been described by way of examples only and it will be appreciated that variation may be made to the above-mentioned embodiments without departing from the scope of invention as defined by the claims, in particular but not solely combination of features of described embodiments.

1. A collar for a recessed fixture, in particular a recessed fixture for recessing in a hole, wherein the collar comprises a wall to extend into the hole, such wall comprising a catch, and such catch arranged to catch the fixture.

2. The collar of claim 1, wherein the catch is arranged to prevent or inhibit a portion of the recessed fixture passing the collar.

3. The collar of claim 1 wherein the catch is an indented catch and the collar comprises a channel within which the indented catch is disposed, for receipt of the sprung arms of the fixture.

4. The collar of claim 1 wherein the collar comprises a channel extending from top to bottom of the wall.

5. The collar of claim 1 wherein the catch comprises a locking mechanism for the sprung arms of the fixture.

6. The collar of claim 1 wherein the locking mechanism comprises a sloped stud.

7. The collar of claim 1 wherein the collar comprises a lip extending from the bottom edge of the wall.

8. The collar of claim 7 wherein the lip comprises slots to aid viewing of the fixture above the lip.

9. The collar of to claim 2, wherein the collar comprises a guide for positioning the sprung arms in line with the channel when the catch is not engaged with the sprung arms.

10. The collar of claim 3 wherein the collar comprises a cutout in the wall to allow sideways passage of a transformer.

11. The collar of claim 1 wherein the collar comprises intumescent material.

12. The collar of claim 1 wherein the catch comprises a slot having a substantially flat base, the slot for receiving a substantially linear end portion of the sprung arm.

13. The collar of claim 12, wherein the slot is disposed between a first sloped stud and a second sloped stud.

14. The collar of claim 1, wherein an exterior surface of the wall comprises screw threading for screwing the collar into the hole.

15. The collar of claim 12, wherein the screw threading comprises a sharp leading edge for cutting into the material around the edges of the hole through which the collar is being inserted.

16. The collar of o claim 12, comprising one or more engagement formations for engaging with a tool.

17. The collar of claim 13, wherein the engagement formations comprise engagement slots within the inner surface of the wall.

18. The collar of claim 14, wherein the engagement slots are shaped and/or dimensioned such that if a rotational torque applied by the tool exceeds a predetermined threshold, the tool will jump out of the collar.

19. The collar of claim 15, wherein the engagement slots extend less than 10 mm, preferably less than 7 mm, still more preferably less than 6 mm and most preferably approximately 5 mm, from an edge of the collar wall receiving the tool.

20. A device comprising the collar of claim 1 and a fixture.

21. A tool for installing the collar of claim 14 into the hole, the tool comprising one or more engagement formations for engaging with the engagement formations of the collar, wherein rotation of the tool while engaged with the collar causes the collar to be screwed into the hole via the screw threading.

22. The tool of claim 21, comprising an engagement surface for insertion within the inside of the wall of the collar, the engagement surface comprising one or more protrusions around its periphery which are complementary in shape with the engagement slots in the inner surface of the wall.

23. The tool of claim 21, wherein the protrusions are shaped and/or dimensioned such that if a rotational torque applied by the tool exceeds a predetermined threshold, the tool will jump out of the collar.

24. (canceled)

25. A collar for a recessed fixture, in particular a recessed fixture for recessing in a hole, wherein the collar comprises a wall to extend into the hole, such wall comprising an indented catch, and such catch arranged to catch a portion of the recessed fixture and prevent or inhibit a remainder portion of the recessed fixture passing the collar.

26. A collar according to claim 1, wherein the catch is arranged to catch a sprung arm of the fixture to retain the collar and fixture together with the sprung arms trapped therebetween.
